(19) United States
(12) Patent Application Publication
(10) Pub. No.: US 2007/0073427 A1
(43) Pub. Date: Mar. 29, 2007

(54) Audio signal processing device

(75) Inventor: Kazuhiko Udagawa, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/526,668

(22) Filed: Sep. 26, 2006

(30) Foreign Application Priority Data
Sep. 27, 2005 (JP) 2005-279816

(51) Int. Cl. G06F 17/00

(52) U.S. Cl. 700/94

(57) ABSTRACT

An audio signal processing device includes a digital stream signal processing device which outputs a multi channel surround sound stereo signal as an FL-FR stream signal which includes front L and R signal components and an SL-SR stream signal which includes surround L and R signal components. Moreover, this audio signal processing device includes a selector circuit which selects and outputs either one of the FL-FR stream signal and the MIXL-MIXR stream signal, based upon a two channel sound/multi channel sound changeover signal. And this audio signal processing device also includes a D/A converter which outputs the output of the selector circuit as front L and R analog signals.

### CROSS REFERENCE

This Nonprovisional application claims priority under 35 U.S.C. § 119(a) on Patent Application No. 2005-279816 filed in Japan on Sep. 27, 2005, the entire contents of which are hereby incorporated by reference.

### BACKGROUND OF THE INVENTION

The present invention relates to an audio signal processing device which is applied to a multi channel surround sound system such as a 5.1 channel surround sound system or the like.

An audio signal processing device in a prior art multi channel surround sound system comprises a digital stream signal processing device which outputs a multi channel surround sound stereo signal from a sound source device housed interior to a DVD player or the like as a plurality of digital stream signals. For example, in the case of a 5.1 channel surround sound system, such a digital stream signal processing device outputs digital stream signals of four types: an FL-FR stream signal (hereinafter termed “stream #1”) which includes front L and R signal components; an SL-SR stream signal (hereinafter termed “stream #2”) which includes surround L and R signal components; a C-SW stream signal (hereinafter termed “stream #3”) which includes center and sub-woofer signal components; and a MIXL-MIXR stream signal (hereinafter termed “stream #4”) in which, in order to correspond to a two-channel sound source, the multi channel surround sound stereo signal are synthesized into L and R signals for two channels.

With this type of system, in order to select between a 5.1 channel surround sound source and a two channel sound source, in the prior art, as shown in FIG. 1, an analog switch 120 is provided in the stream signal output system, and this analog switch 120 is switched over. FIG. 1 is a schematic structural diagram showing such an audio signal processing device according to the prior art.

A micro computer 1 in FIG. 1 (hereinafter termed a microcomputer) corresponds to the above described digital stream signal processing device. This microcomputer 1 outputs a total of four 5.1 channel surround sound stereo signals from a sound source device (not shown in the figure) which is housed interior to a DVD player or the like: ADOUT0 (corresponding to stream #1); ADOUT1 (corresponding to stream #2); ADOUT2 (corresponding to stream #3); and ADOUT3 (corresponding to stream #4).

FIG. 2 shows the details of each of these signals ADOUT0 through ADOUT3. In detail, ADOUT0 is an FL,FR audio data signal (an FL-FR stream signal which includes front L and R signal components). Furthermore, ADOUT1 is an SL,SR audio data signal (an SL-SR stream signal which includes surround L and R signal components). Moreover, ADOUT2 is a C,SW audio data signal (a C-SW stream signal which includes center and sub-woofer signal components). Finally, ADOUT3 is a MIXL,MIXR audio data signal (a MIXL-MIXR stream signal) in which the 5.1 channel surround sound stereo signal is synthesized into a two channel L and R signal.

ADOUT0 through ADOUT3 are converted into analog signals by respective DACs (D/A converters) 101 through 104, and are separated into signals (FL,FR), (SL,SR), (C,SW), and (MIXL,MIXR). And noise elimination and the like is performed upon these signals (FL,FR), (SL,SR), (C,SW), and (MIXL,MIXR) by LPFs (low pass filters) 111 through 114. The signal (FL,FR) which has passed through the LPF 111 and the signal (MIXL,MIXR) which has passed through the LPF 114 are inputted to the analog switch 120 (hereinafter termed an analog SW). And either one of the (FL,FR) signal and the (MIXL,MIXR) signal is selected by the analog SW 120, according to a two channel sound/5.1 channel surround sound changeover signal. In other words, if two channel sound is set, then (MIXL,MIXR) is selected. On the other hand, if 5.1 channel surround sound is set, then (FL,FR) is selected.

And speakers not shown in the figure are connected at a stage subsequent to the analog SW 120. The user is able to hear voice upon these speakers, based upon the audio signal which is outputted from the analog SW 120.

On the other hand, with a 5.1 channel surround sound audio system such as a home theater or the like, sometimes a structure is employed in which the changeover of the input data is performed at the digital stream stage (for example, refer to Japanese Laid-Open Publication 2005-175799).

However, with a structure like that of FIG. 1, since the switching over between multi-channel sound and two-channel sound is performed by the analog SW 120, sometimes this switchover has experienced some influence due to heat noise in the peripheral circuitry. In other words, there has been the problem that, due to the use of this analog SW 120, the quality of the sound has been deteriorated.

Furthermore, with the audio system described in the above Japanese Laid-Open Publication 2005-175799, at the digital stream stage, it is only possible to change over the input data. Accordingly, the audio system described in the above Japanese Laid-Open Publication 2005-175799 is not one with which, for a multi channel surround sound system, it is possible to perform changeover between multi channel surround sound such as 5.1 channel surround sound or the like and two channel sound.

A feature of the present invention is, for a multi channel surround sound system, to provide an audio signal processing device which is capable of performing changeover between multi channel surround sound and two channel sound, without decreasing the quality level of the signal.

### SUMMARY OF THE INVENTION

The audio signal processing device according to the present invention includes a digital stream signal processing device which, from a multi channel surround sound stereo signal, outputs stream signals of four types: an FL-FR stream signal which includes front L and R signal components; an SL-SR stream signal which includes surround L and R signal components; a C-SW stream signal which includes a center and a sub-woofer signal components; and a MIXL-MIXR stream signal in which the multi channel surround sound stereo signal has been synthesized into L and R signals for two channel sound. With this structure, the multi channel surround sound stereo signal is transmitted from a sound source device which is housed interior to an optical disk device or the like. In the case of, for example, an optical disk device, the sound source device may consist of a pickup which reads data from the optical disk and its peripheral circuitry. The optical disk device may be, for example, a DVD player.

Furthermore, this audio signal processing device includes a selector circuit to which the FL-FR stream signal and the MIXL-MIXR stream signal are inputted, and selects and outputs either one of these two signals which have been inputted based upon a two channel sound/multi channel sound changeover signal.

Moreover, this audio signal processing device includes a D/A converter which: outputs the output of the selector circuit as front L and R analog signals; outputs the SL-SR stream signal outputted from the digital stream signal processing device as surround L and R analog signals; and outputs the C-SW stream signal outputted from the digital stream signal processing device as a center analog signal and a sub-woofer analog signal.

With this structure, the selector circuit performs changeover between multi channel sound and two channel sound at the digital stream stage.

### BRIEF DESCRIPTION OF THE DRAWINGS

FIG. 1 is a schematic structural diagram of an audio signal processing device according to the prior art;

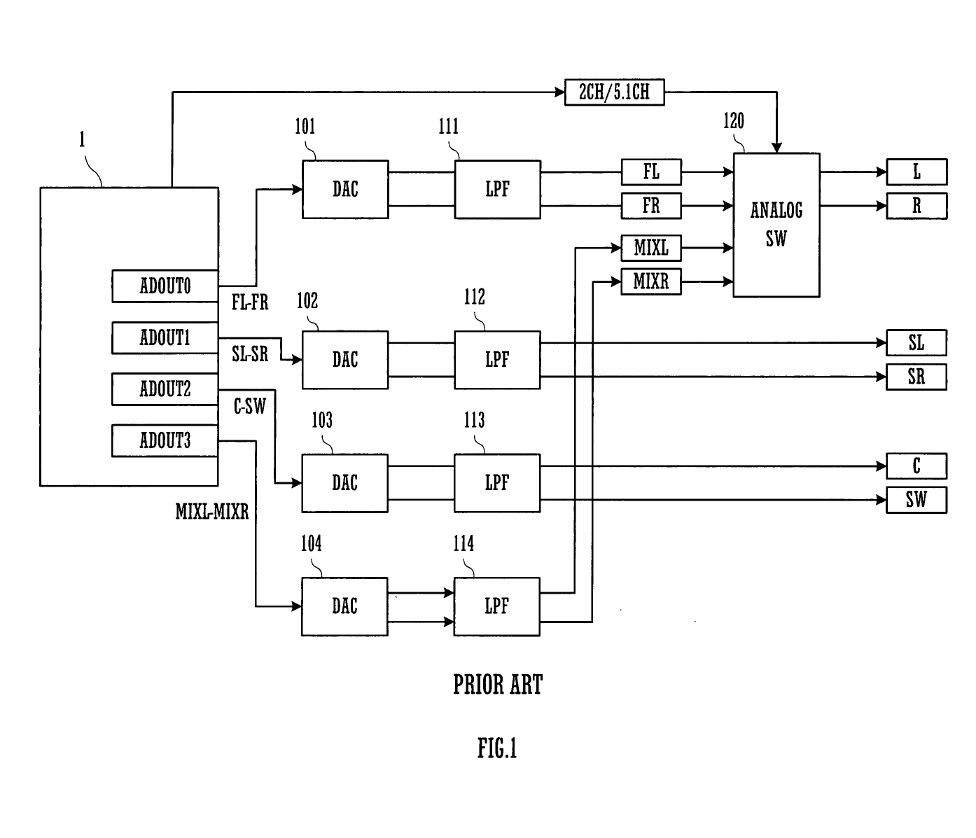

FIG. 2 is a figure showing the details of certain signals ADOUT0-ADOUT3;

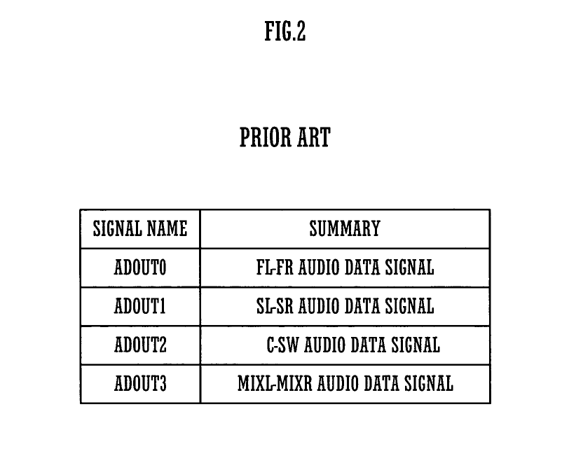

FIG. 3 is a schematic structural diagram of an audio signal processing circuit which is an embodiment of the present invention;

FIG. 4 is a figure showing the details of certain signals ADOUT0-ADOUT3; and

FIG. 5 is a structural diagram showing essential portions of a control circuit.

### DETAILED DESCRIPTION OF THE INVENTION

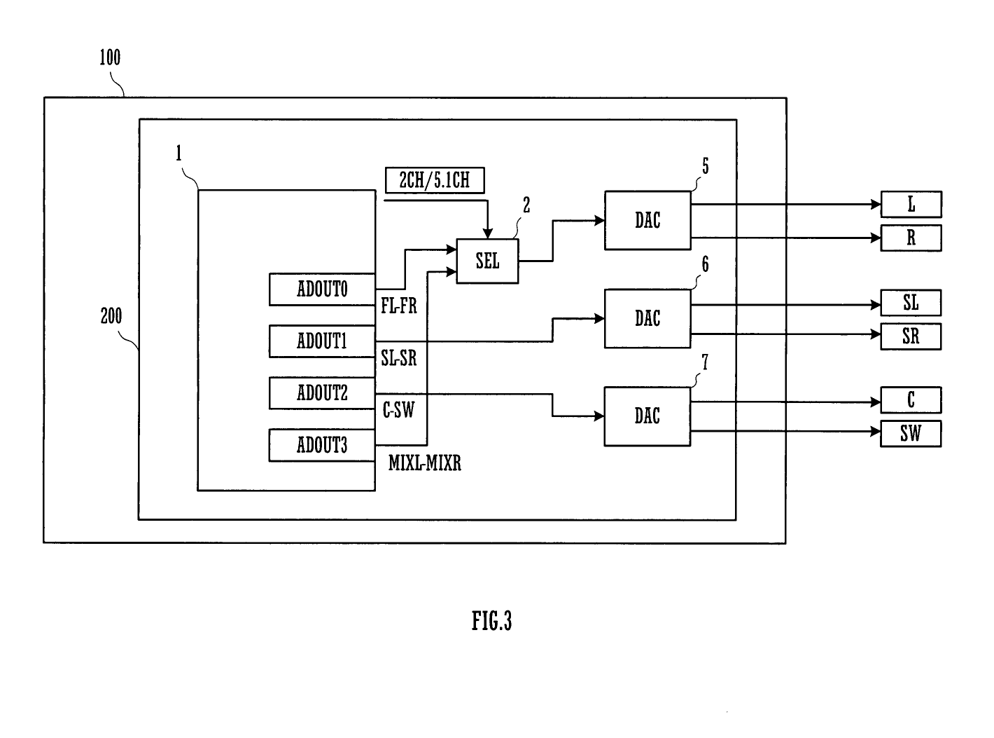

FIG. 3 is a schematic structural diagram of an audio signal processing circuit which is an embodiment of the present invention. This audio signal processing circuit 200 comprises a microcomputer 1, a selector circuit 2, and DACs 5 through 7.

The microcomputer 1 receives a 5.1 channel surround sound stereo signal from a sound source device (not shown in the figures) which is housed within a DVD player 100. This sound source device includes a pickup, and its peripheral circuitry, that read data from an optical disk.

Here, in this embodiment, the above described audio signal processing circuit 200 is disposed at the output side of the DVD player 100. Furthermore, this audio signal processing circuit 200 and the sound source device constitute a multi channel surround sound system. Moreover, the microcomputer 1 corresponds to the “digital stream signal processing device” of the Claims. And the above described audio signal processing circuit 200 corresponds to the “audio signal processing device” of the Claims.

And the microcomputer 1 outputs the 5.1 channel surround sound stereo signals ADOUT0 (corresponding to stream #1), ADOUT1 (corresponding to stream #2), ADOUT2 (corresponding to stream #3), and ADOUT3 (corresponding to stream #4). At the stage that these are outputted, the decoding processing or encoding processing for these streams has already been performed.

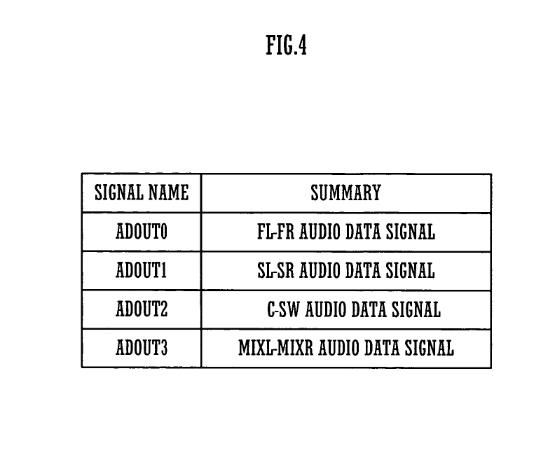

FIG. 4 shows the details of each of these signals ADOUT0 through ADOUT3. In detail, ADOUT0 is an FL,FR audio data signal (an FL-FR stream signal which includes front L and R signal components). Furthermore, ADOUT1 is an SL,SR audio data signal (an SL-SR stream signal which includes surround L and R signal components). Moreover, ADOUT2 is a C,SW audio data signal (a C-SW stream signal which includes center and sub-woofer signal components). Finally, ADOUT3 is a MIXL,MIXR audio data signal (MIXL-MIXR stream signal) in which the 5.1 channel surround sound stereo signal has been synthesized into L and R signals for two channel sound.

It should be understood that, by front L and R signals, there are meant signals which are inputted to speakers which are disposed forward and left of the listener, and forward and right of the listener, respectively. Furthermore, by surround L and R signals, there are meant signals which are inputted to speakers which are disposed rearward and left of the listener, and rearward and right of the listener, respectively. Moreover, by the center signal is meant a signal which is inputted to a speaker which is disposed forward of the listener, in the middle. Finally, by the sub-woofer signal is meant a signal which is inputted to a speaker which is disposed a given position. The sub-woofer speaker only replays heavy bass sound.

ADOUT1 and ADOUT2, along with being converted into analog signals by the respective DACs (D/A converters) DAC 6 and DAC 7, are also separated into (SL,SR) and (C,SW) and outputted. On the other hand, ADOUT0 and ADOUT3 are inputted into the selector circuit 2. This selector circuit 2 selects either ADOUT0 or ADOUT3, based upon a two channel sound/5.1 channel surround sound changeover signal. The stream signal which has been thus selected is inputted to DAC5. And DAC5 converts this stream signal which has been selected by the selector circuit 2 to two analog signals, and outputs them as (L,R).

The selector circuit 2 selects ADOUT3 when the two channel sound/5.1 channel surround sound changeover signal is set to “two channel sound”. Conversely, the selector circuit 2 selects ADOUT0 when the two channel sound/5.1 channel surround sound changeover signal is set to “5.1 channel surround sound”. Accordingly, the DAC 5 outputs the MIXL,MIXR audio data signals as an analog L signal and an analog R signal when two channel sound is set. Moreover, the DAC 5 outputs the FL,FR audio data signals as an analog L signal and an analog R signal when 5.1 channel surround sound is set.

And speakers not shown in the figure are connected at a later stage than DAC5 through DAC7. The user is able to hear audio based upon the audio signals outputted from DAC5 through DAC7 via these speakers.

According to the above, the selector circuit 2 selects and outputs only one of the stream signals ADOUT0 and ADOUT3. Thus the circuit structure becomes simple, since only a straightforward switching operation is required. Moreover, since the selector circuit 2 changes over between the FL-FR stream signal and the MIXL-MIXR stream signal at the digital stream stage, accordingly the problem of the occurrence of noise, which constituted a problem in the case of performing the changeover with an analog SW, does not occur.

Furthermore, the following variant embodiments of the present invention may be employed.

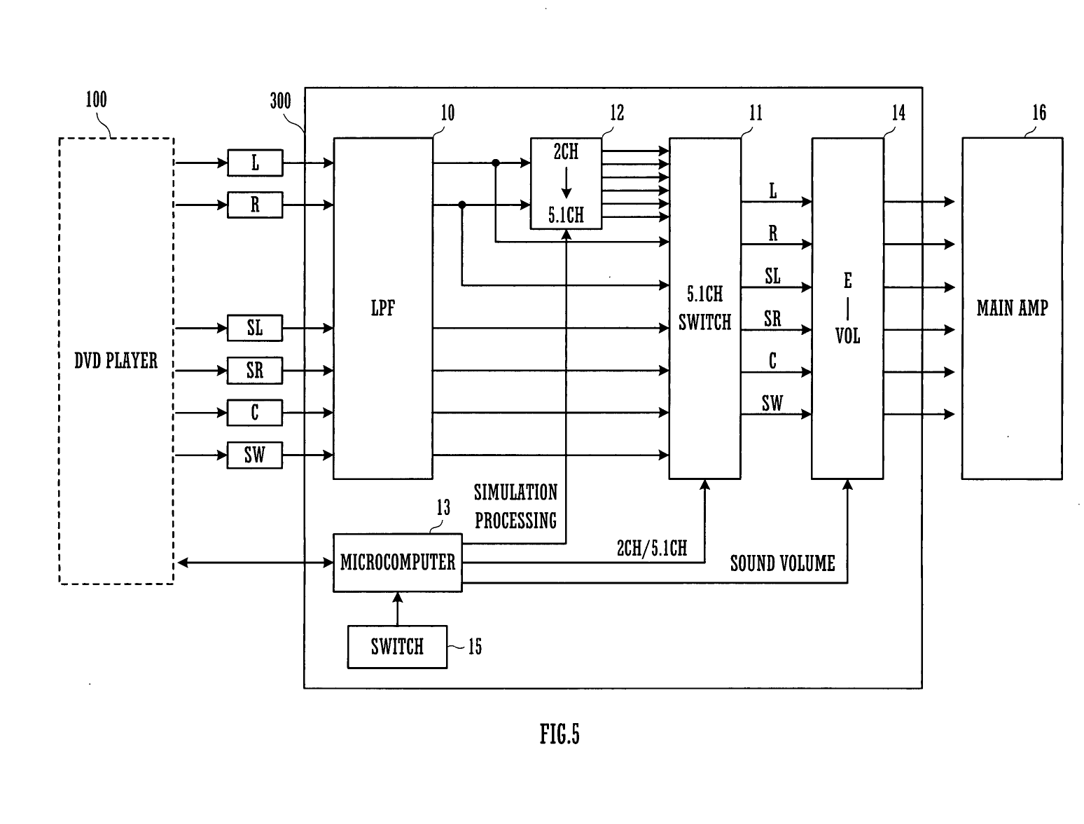

FIG. 5 is a structural diagram showing the essentials of a control circuit of the above described audio signal processing circuit which processes the analog output signals. This control circuit 300, the above described audio signal processing circuit 200, and a sound source device together constitute a multi channel surround sound system. In this variant embodiment, the above described audio signal processing circuit 200 and control circuit 300 correspond to the “audio signal processing device” of the Claims. Moreover, a converter 12 corresponds to the “conversion circuit” of the Claims. And a switch 15 corresponds to the “switch” of the Claims.

The control circuit 300 comprises a LPF 10, a 5.1 channel switch 11, the converter 12, a microcomputer 13, a volume controller 14, and the switch 15.

The analog output signals (L,R), (SL,SR), and (C,SW) from the above described audio signal processing circuit 200 within the DVD player 100 are subjected to low range portion filtration processing by an LPF 10. As a result, noise and the like is eliminated from these signals (L,R), (SL,SR), and (C,SW). The signals (SL,SR) and (C,SW) are transmitted just as they are to the 5.1 channel switch 11. And the 5.1 channel switch 11 changes over between two channel sound input and 5.1 channel sound input according to the two channel sound/5.1 channel surround sound changeover signal. When two channel sound has been selected, the 5.1 channel switch 11 selects and outputs the analog output signals (L,R). Conversely, when 5.1 channel sound has been selected, the 5.1 channel switch 11 selects and outputs the analog output signals (L,R), (SL,SR), and (C,SW).

Furthermore, a two channel sound ->5.1 channel sound converter is provided at the input side of the 5.1 channel switch 11. This converter 12 is a device which converts a two channel sound signal to a pseudo 5.1 channel sound signal. When simulation processing has been selected by the microcomputer 13, the converter 12 converts the two channel sound which is inputted to a 5.1 channel sound signal and outputs it. This signal which has been converted is outputted via the 5.1 channel switch 11 as the analog output signals (L,R), (SL,SR), and (C,SW). This simulation processing is selected when the sound source is two channel sound.

The gains of the various signals in the output signal from the 5.1 channel switch 11 are controlled by a volume controller 14. Here, a signal to this volume controller 14 for controlling the gain is created by the microcomputer 13. And the output signal of the 5.1 channel switch 11 is outputted to a main amp 16 which is provided at a stage after the volume controller 14. And the speakers (not shown in the figure) are connected at a stage after this main amp 16.

By doing this, even in the case when the sound source is two channel sound, the user is able to hear 5.1 channel sound on the speakers in a simulated manner.

It should be understood that the switch 15 which can be actuated by the user is connected to the microcomputer 13. By actuating this switch 15, it is possible for selection of the sound volume, selection of the simulation processing described above, selection between two channel sound and 5.1 channel sound, and so on to be performed (refer to FIG. 5).

What is claimed is:

1. An audio signal processing device, comprising:
a digital stream signal processing device which, from a multi channel surround sound stereo signal, outputs stream signals of four types: an FL-FR stream signal which includes front L and R signal components; an SL-SR stream signal which includes surround L and R signal components; a C-SW stream signal which includes a center and a sub-woofer signal components; and a MIXL-MIXR stream signal in which the multi channel surround sound stereo signal has been synthesized into L and R signals for two channel sound;
a selector circuit to which the FL-FR stream signal and the MIXL-MIXR stream signal are inputted, and selects and outputs either one of these two signals which have been inputted based upon a two channel sound/multi channel sound changeover signal; and
a D/A converter which D/A converts the signal outputted from the selector circuit into front L and R analog signals; D/A converts the SL-SR stream signal outputted from the digital stream signal processing device into surround L and R analog signals; and D/A converts the C-SW stream signal outputted from the digital stream signal processing device into a center analog signal and a sub-woofer analog signal.

2. The audio signal processing device according to claim 1, further comprising a conversion circuit which performs simulation processing by converting the front L and R analog signals into a simulated multi channel surround sound stereo signal.

3. The audio signal processing device according to claim 2, further comprising a switch for selecting whether or not simulation processing by the conversion circuit is to be made effective.
